(19) United States
(12) Patent Application Publication
(10) Pub. No.: US 2013/0185331 A1
(43) Pub. Date: Jul. 18, 2013

(54) Medical Imaging Management System

(71) Applicant: Christopher Conemac, Orlando, FL (US)

(72) Inventor: Christopher Conemac, Orlando, FL (US)

(21) Appl. No.: 13/622,163

(22) Filed: Sep. 18, 2012

Related U.S. Application Data
(60) Provisional application No. 61/536,542, filed on Sep. 19, 2011.

(51) Int. Cl. G06F 17/30

(52) U.S. Cl. CPC G06F 17/30283
USPC 707/783

(57) ABSTRACT

An improved system, method, and computer-readable instructions for medical image management is provided. The system includes one or more server devices adapted to receive and centrally store a plurality of medical images in a cloud environment, wherein metadata is separated from image data via the processor; the server devices adapted to provide access to the medical images via a remote log in upon authentication via the processor, wherein the access comprises access to view data authorized for the particular user and images associated therewith; and enable viewing of accessed data via a remote viewing device for the particular user that deploys a cloud-enabled application in the cloud environment rather than downloading the images to the remote device.

### CROSS-REFERENCE TO RELATED APPLICATIONS

This application claims priority from U.S. provisional application Ser. No. 61/536,542, filed Sep. 19, 2011, the disclosure of which is incorporated herein by reference in its entirety.

### TECHNICAL FIELD

This invention relates to medical image management, and specifically to an improved system, method, and computer-readable instructions for centralized storage, management, and viewing of medical images, including radiology images, using a network of remote servers hosted on a global communication network to store, manage, and process data and images, rather than a local server or personal computer, including providing capabilities as a service to multiple users using Internet technologies as part of a cloud environment.

### BACKGROUND ART

From a health care provider's point of view, there is an immediate need to speed up the process of getting medical images/radiology to doctors and health care providers in a faster and more efficient fashion. The old methods of providing an image to a doctor are slow, costly, use up large amounts of bandwidth, and require enormous amounts of storage space. As a result, patient lives are at stake because the only way to obtain immediate access to images from anywhere results in a stripped down web interface and degradation of quality on the doctor's actual viewing/reporting software. Inefficiencies exist because moving large images takes large amounts of bandwidth. Moreover, storing images at radiology centers across the country means large amounts of storage and no centralization of data.

From an Insurance Company (Carrier) point of view, there is a need to reduce or eliminate unnecessary costs resulting from inefficiency resulting from duplication, fraud, and unnecessary or poor quality images. For example, many carriers are paying about 40% extra in radiology costs each month solely due to inefficiency. Because carriers are unable to have access to images that are located at the radiology centers, they must wait for faxed or emailed reports after some time has passed and the image has already been taken. A carrier has no way of knowing or stopping a doctor from taking another image after the hospital has already taken one a week prior.

The development and proliferation of “cloud computing” and “cloud storage” has greatly enhanced the ease with which users interact with central databases/data. In general, a cloud-based architecture deploys a set of hosted resources such as processors, operating systems, software and other components that can be combined or linked together to form virtual machines. A particular cloud may reside in a single server or platform, or may be distributed among multiple servers or systems.

A number of patents and published applications exist which relate to medical imaging or cloud computing including US Publication Nos. 20020019751, 20020052851, 20080080526, 20080215732, 20100036879, 20110055161, 20110110568, 20110209064, and 20110214124, all of which are incorporated herein by reference in their entireties to the extent they are not inconsistent with the explicit teachings of this specification.

Accordingly, there is a need in the art to provide more effective ways to store and retrieve medical images and to reduce costs associated therewith, included unnecessary costs resulting from inefficiency. There is a further need in the art to have the image centralized in a central point that can deploy this image anywhere in the world in real time. The present invention is designed to address these needs.

### SUMMARY OF THE INVENTION

Broadly speaking, a medical image management system, method, and computer-readable medium are provided. The system and method comprises centralized storage, management, and viewing of medical images, including radiology images, using a network of remote servers hosted on a global communication network to store, manage, and process data and images, rather than a local server or personal computer, including providing capabilities as a service to multiple customers using Internet technologies as part of a cloud computing environment. Imagery is accessible anywhere in the world in real time, using any full functional viewing software available without installing it, rather deploying it through a cloud environment. The system and method also provides an insurance carrier interface that generates alerts, including those for image duplication, claim fraud, poor quality.

The invention provides the centralization, deployment and management of radiology images in real time eliminating fraud and abuse as well as duplication. It also adds ease of accessibility for the health care provider and insurance carrier, allowing them to view and report on images, non-compressed and in real time anywhere in the world without actually having to download the image. The invention provides for viewing images using a cloud based environment that eliminates onsite storage for health care providers/hospitals and related bandwidth constraints for the viewing radiologist.

The medical image management system is adapted to receive and store data (e.g., image separated from with meta data) received from a medical imaging device. The system is arranged to receive the data, process the data, store the data in a cloud environment, and provide access to the data in a visible format. The cloud service comprises a database and a repository for storing medical imaging records.

The invention can be implemented in numerous ways, including as a system, a device/apparatus, a method, or a computer readable medium. Several embodiments of the invention are discussed below.

As a system, an embodiment of the invention includes a plurality of data centers with servers on which images have been replicated, encrypted (HIPAA), and stored, with the data centers operating in the cloud for world-wide access. The cloud may reside in a single server or platform, or may be distributed among multiple servers or systems. Images are viewable therefrom using a remote viewer (such as GE Centricity® Viewer, or similar viewer). After logging on to the data center by the health care provider (e.g., by username and password), the appropriate viewer will deploy from the data center as a remote application. Once logged in, the remote viewer deploys to provide a list of the doctor's patients in real time. Images for those patients are then accessible uncompressed and un-degraded. The doctor can then view and report on images without ever downloading them, using his/her own viewing software.

As a method, an embodiment of the invention comprises receiving images from radiology centers, and the like, extracting Meta data therefrom, replicating, encrypting, and storing on one or more data centers operating in the cloud for world-wide access. Upon receiving a request for access (e.g., a log in request authenticated with username/password), access to that user's patient list and associated data images is provided. That user's viewer application is deployed “in the cloud” so that the user can view his patient's associated images with his remote viewer. The remote viewer (personal computer, mobile/hand held device, etc.) then displays the images without downloading them to the remote device.

The system and method further provide an insurance interface module which provides additional functionality directed to reducing duplication and fraud. The insurance interface module performs checks on the received data/images and sends alerts for detected duplication/fraud.

The methods of the present invention may be implemented as a tangible/non-transitory computer program product/computer readable medium with a computer-readable medium having code thereon.

As an apparatus, the present invention may include at least one processor, a memory coupled to the processor, and a program residing in the memory which implements the methods of the present invention.

The advantages of the invention are numerous, including, for example, one or more of: no onsite storage space needed anymore, no need for bandwidth, no need for backups, no need for IT support on imaging equipment, no need to learn a new viewer (a user can use his current viewer), no compression, no data loss, no downloading of image, optionally eliminate PACS machines and associated costs, multi layer encryption, reduce overall cost, real time data center replication and backups, multiple years of offsite storage and archiving, mobile device support—(e.g., Iphone®/Ipad®/Android® devices), kernel based cloud technology in deployment, no installation required, no hardware or software required, no web browser needed, fully functional deployment of current provider software, no need to relearn new imaging viewer, no onsite visit to setup practice or viewing location, centralized storage for all imaging data, platform neutral—PC, MAC, Linux, Mobile Device, no software installation, no need to have an IT professional assign permissions or setup, no need for doctor to have a fast computer, cut costs, cut hassles, increase capabilities, better patient care due to speed of report and image review, eliminate fraud and abuse, duplication, poor quality.

Other aspects and advantages of the invention will become apparent from the following detailed description taken in conjunction with the accompanying drawings, illustrating, by way of example, the principles of the invention.

All patents, patent applications, provisional applications, and publications referred to or cited herein, or from which a claim for benefit of priority has been made, are incorporated herein by reference in their entirety to the extent they are not inconsistent with the explicit teachings of this specification.

### BRIEF DESCRIPTION OF THE DRAWINGS

In order that the manner in which the above-recited and other advantages and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is an overview of an embodiment platform of the present invention.

FIG. 2 is a bock diagram of a computing system for implementing aspects of the invention.

FIG. 3 is a navigational flowchart of an embodiment of the invention.

### DETAILED DESCRIPTION OF THE PREFERRED EMBODIMENT

Referring now to the drawings, the preferred embodiment of the present invention will be described. As utilized herein, terms “component,” “system,” “interface,” “network,” “cloud,” “service,” and the like are intended to refer to a computer-related entity. Furthermore, the claimed subject matter may be implemented as a method, apparatus, or article of manufacture using standard programming and/or engineering techniques to produce software, firmware, hardware, or any combination thereof to control a computer (i.e., machine) to implement the disclosed subject matter. In addition, a “cloud” is intended to refer to a collection of resources (e.g., hardware/software) provided and maintained by an off-site party (e.g., third party), wherein the collection of resources can be accessed by an identified user over a network (e.g., Internet, WAN, . . . ).

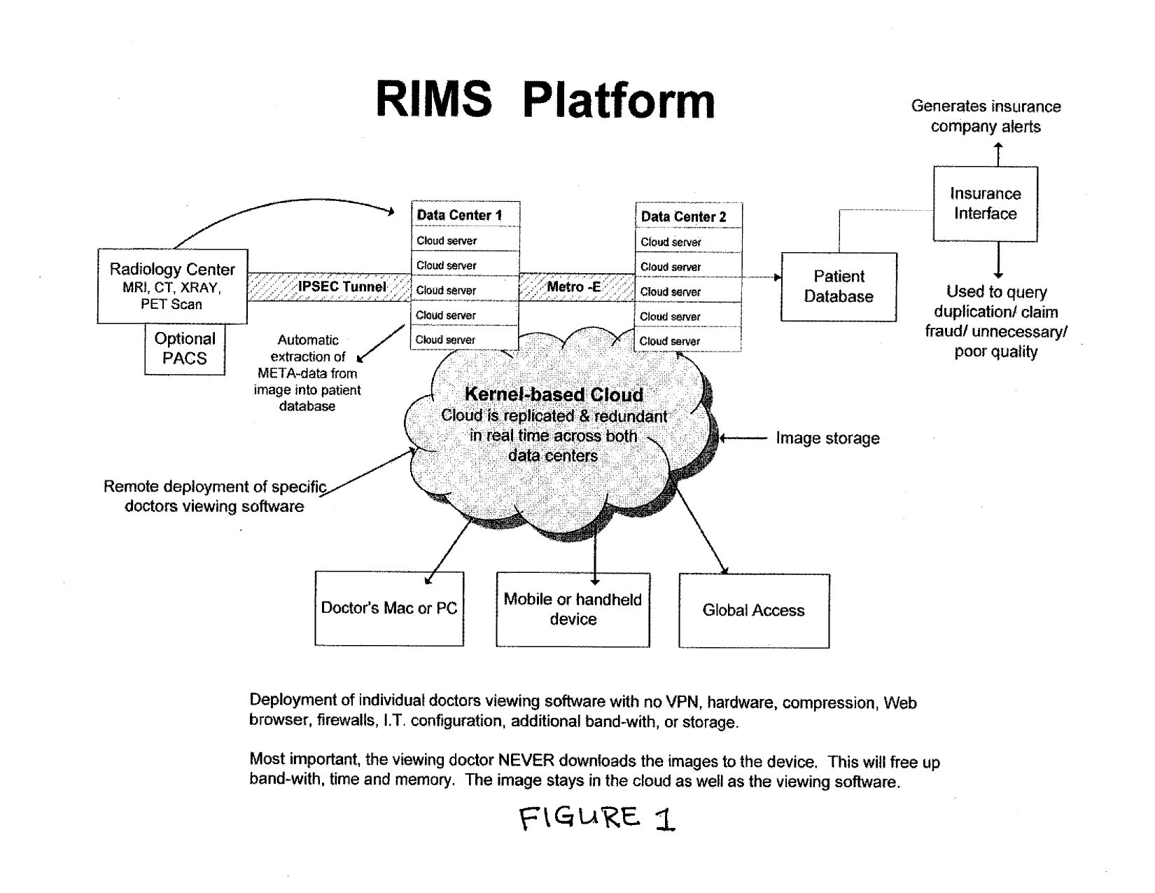

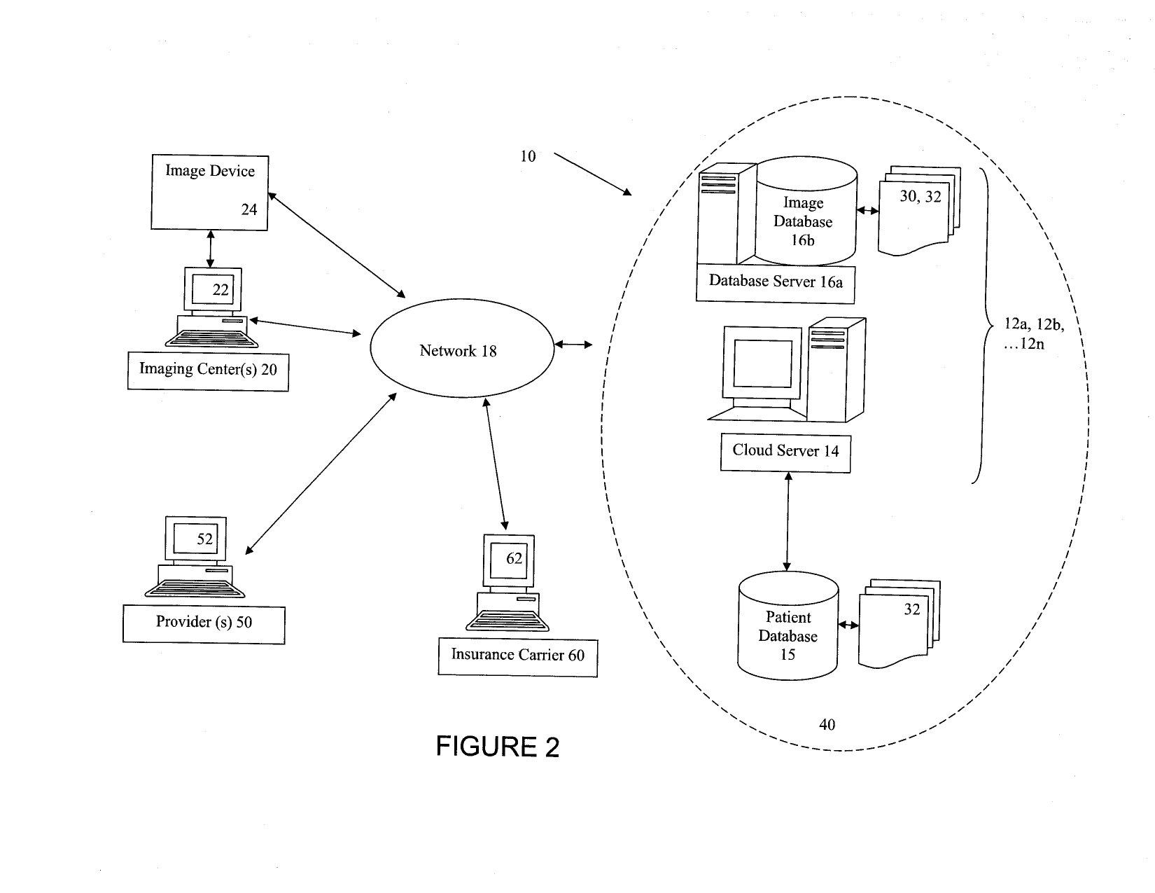

In an embodiment of the present medical image management system 10 (FIGS. 1-2), the system will generally include one or more data centers 12a, 12b, . . . 12n with one or more cloud servers 14, firewalls and routing equipment for security and access, and a cloud computing environment (e.g., Kernel Based Cloud environment). Software/modules are provided to support global file system storage, image replication, authentication, storage/database management, remote application deployment, and an Insurance Carrier Interface.

A cloud server 14 generally comprises server component(s) which can be a personal computer, a minicomputer, or a mainframe, or the like. The cloud server offers, for example, data management/storage, information sharing, networking and security. As part of or in addition to the cloud server 14 is a database server 16a (such as a RDBMS—Relational Database Management System). The database 16b is preferably connected to a database server component 16a and can be any device which will hold data. For example, the database 16b can consist of any type of magnetic or optical storing device for a computer (e.g., CDROM, internal hard drive, tape drive). The database 16b can be located remote to the server component 16a (with access via modem or leased line) or locally to the server component 16a. The database 16b may be a relational database that is organized and accessed according to relationships between data items. The relational database would preferably consist of a plurality of tables (entities). The rows of a table represent records (collections of information about separate items) and the columns represent fields (particular attributes of a record). The present invention also envisions other computing arrangements for the server(s) 14, 16a, including processing on a single machine such as a mainframe, a collection of machines, or other suitable means.

The cloud server 14 includes a processor, memory, bus, input/output, and the like in accordance with known techniques. All of these configurations, as well as the appropriate communications hardware and software, are known in the art. The communications network 18 is preferably a global network such as the Internet, but may be an Intranet or the like.

Software programming code which embodies the present invention is typically stored in permanent non-transitory storage of some type, such as the permanent storage of the cloud server 14. Such software programming code may be stored with storage (not shown) associated with the server. The software programming code may be embodied on any of a variety of known media for use with a processing system, such as a diskette, or hard drive, or CD-ROM, DVD, flash drive, or the like. The techniques and methods for embodying software program code on physical media well known and will not be further discussed herein.

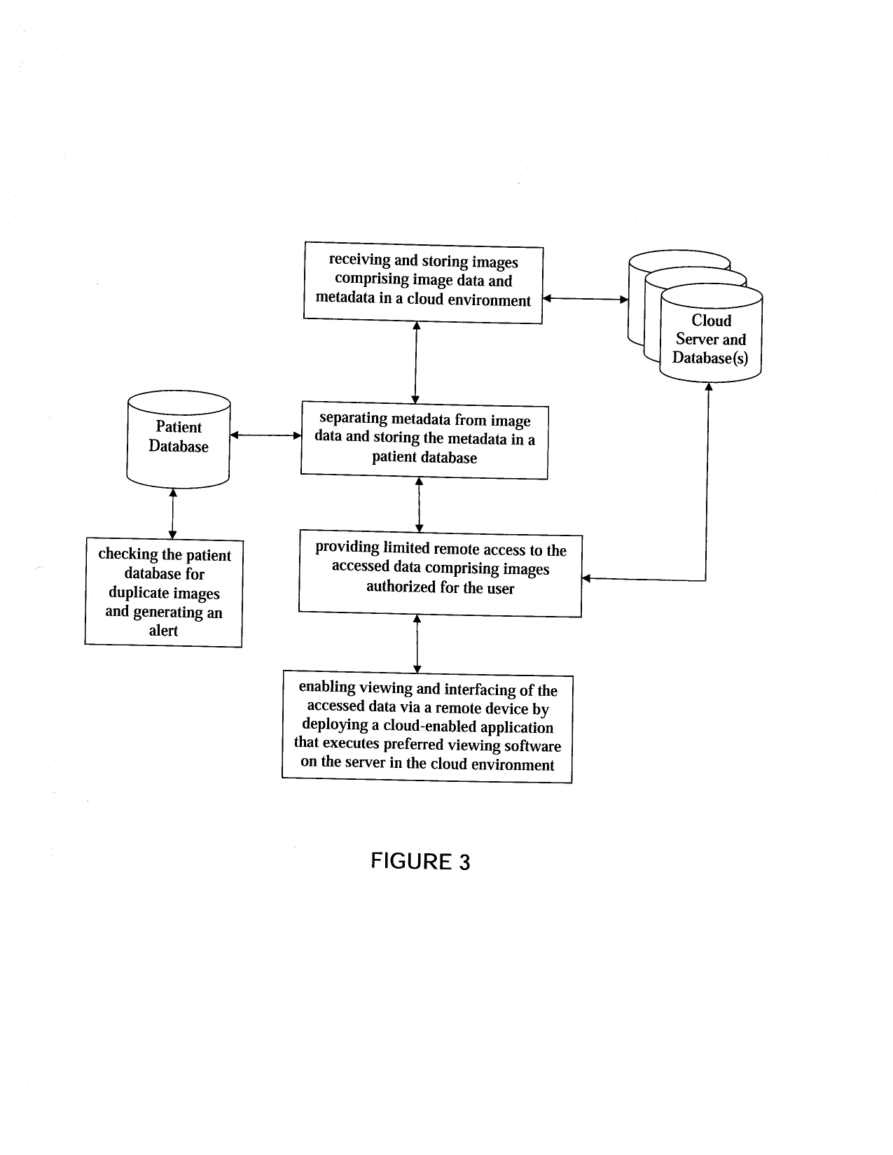

As a method (FIG. 3), an embodiment of the invention generally comprises three sections (image storage, image access, and insurance carrier interface), as detailed below.

1. Image Storage

After an image 30 is taken at a Radiology Center 20 (and possibly stored on a local PACS machine 22 if used) it is received at a first data center 12a. Once received at the first data center 12a, it is then replicated via a processor in real time and distributed/communicated to one or more other data centers 12b, . . . 12n. At the data centers 12a, 12b, . . . 12n, the images 30 are seamlessly sorted (e.g., by doctor) and secured. The image 30 is also stripped of all its META DATA (Patient information, payor information, modality . . . etc). Once stripped, the META Data 32 is stored in the database 15 (e.g., dumped into a MySQL database).

Preferably, a port/AE-title and IP address are provided to the Radiology department 20 to add into their system 22 as a place to replicate images. Then when the image 30 is taken it automatically is centralized in the data centers 12a, 12b, . . . 12n of the system 10. This is standard information that any piece of imaging equipment 24 can use in order to take and dump an image 30 either locally or offsite. The process is highly scalable and can be setup on the image-taking side without having to go onsite or install any sort of extra hardware.

2. Image Access

The image 30 is now accessible from anywhere by a client 50 (such as a doctor) via viewing software of a remote processing device 52 through a remote deployment of an app (cloud-enabled application) into the cloud 40. The remote app logs into the cloud environment 40 to view stored patient information in real time, uncompressed, and to view, manipulate and report on an image 30 thereof. The app may be sent as shortcut that will deploy a user's own radiology viewing application from anywhere so a user (doctor) can view his patients' data without downloading the image or installing a viewing application on the remote device 50. Any other doctor in the world can log in and, if authorized, see the same images 30 in real time as well. A client, viewing side, shortcut may be used to initiate the viewing session with the doctor's viewer of choice. The doctor can have access to this shortcut and can download, email, or store it on a removable drive for use anywhere.

3. Insurance Carrier Interface

Insurance carriers 60, via a remote processing device 62, can now see a generation of alerts through a unique web interface that shows when an image 30 is a duplicate and/or fraudulent. Insurance carriers 60 have access to this report and image 30 in real time to properly manage patients. Insurance carriers 60 no longer need to pay a second claim for an image taken twice.

Operation of the invention involves the remote access and quality assurance of radiology images 30 across a platform neutral landscape in real time using the doctor's preferred viewing software on his remote processing device 52.

For the health care provider 50, installation preferably comprises a shortcut that will remotely connect to the cloud-enabled application. For Insurance Carriers 60, there is no separate installation as access is provided through a browser that simply opens up a website to allow for logging in. In operation, from the health care provider's point of view, the doctor simply clicks on a shortcut that can be downloaded anywhere. Then he logs in for authentication. Based on the username and password he logs in with will determine which piece of viewing software will deploy remotely for the doctor on his remote processing device 52. The doctor will only see his patents listed in his own viewing software. The doctors are then able to access images 30 in real time, uncompressed and underrated using their viewing software of choice to see their patents.

From the Insurance Carrier 60 point of view, Insurance carriers 60 may log in with a website interface (browser) on their remote processing device 62 and see in real time any alerts generated for images 30 that have been determined by the medical image management system to be duplicates, unnecessary, poor quality, fraudulent, etc. Insurance Carriers 60 will be able to reduce or eliminate fraud, abuse, unnecessary, poor quality, duplicate images thereby avoiding payment of claims that are unnecessary.

The medical image management system 10 can be integrated with any Hospital IT system or software platform to allow for immediate transmission of images 30 to the cloud server 14.

Following are examples which illustrate procedures for practicing the invention. These examples should not be construed as limiting.

The following defined terms are used herein:

RIMS—Radiology Imaging Management System 10 is an embodiment of the system/method of the present invention for centralizing and deployment of radiology imagery 30 to any Internet capable device 52 anywhere in the world without actual transfer of images to the client viewing device 52.

ClaimPRO—Website interface written to query the META Data extracted database 15 that is created by RIMS when images 30 are centralized. ClaimPro is able to query information that an insurance carrier 60 would use to eliminate claim fraud, duplication, unnecessary and poor quality images.

PACS—(Picture Archiving and Communication System) 22 works with DICOM (Digital Imaging and Communications in Medicine) technology for storage, retrieval and access of medical images 30.

When a doctor 50 is at a computer 52 in a hospital and he needs to access an image 30 that is located at a Radiology center 20 offsite, prior to this invention he would need to use a remote viewing web browser interface to download and view the image in a compressed degraded format. This requires the I.T. department to allow access to this specific web site address to allow downloading of this image. Also requires the hospital I.T. department, typically, to install a viewing software client on the viewing PC that requires admin permissions to do. However, with the present invention, the doctor 50 can bring a shortcut with him or open his email and click on it on his remote processing device 52. Then his own viewing application opens with his full uncompressed images 30 of only his patents being shown in a list, available for instant viewing and reporting. No software client installation. No contacting and having to setup anything at the firewall level or bother the I.T. dept at the hospital in any way. No having to allow things in a hospital content filtering system. Just click on the shortcut and once logged in the doctor 50 can immediately complete his tasks with no other human interaction. Prior to this invention, the storage, bandwidth, and I.T. management are biggest cost hits when it comes to radiology. The storage is an ongoing concern that all imaging companies are always paying for. It is going to increase each and every day that they are in business. With the image management system 10 of the present invention, there would no longer be a need to pay this recurring cost. The same applies with bandwidth. There would be a dramatic drop in the demand for huge internet pipes used to move images all over the place. Companies invest in hardware but they also hate doing so because of the liability they now face being solely responsible for the accessibility of their imagery and the ongoing storage of it for the period of no less than 10 years. The image management system 10 of the present invention would drastically reduce that cost for the client. A typical lifespan for an Enterprise network server is 3 years. Companies are constantly purchasing more and more hardware, software, data centers, IT support, bandwidth, VPN devices . . . etc . . . all to accomplish what the image management system 10 of the present invention accomplishes.

Hospitals would use the image management system of the present invention to give better quality, instant viewable imagery to their employed doctors and referring physicians. This would be a way of the hospital getting more referrals based on the advanced easy access technology that they would employ. The hospitals would be saving a substantial cost on storage and bandwidth. Typically 50-250 k per year for a single radiology center, with maybe 2 docs onsite just for the storage and bandwidth costs. Also savings on doctor costs to bring them onsite every time they need to do an image read. Hospitals would be saving lives based on the fact that a specialist in radiology could read a trauma patent's image before even leaving his house to drive 20 minutes to the hospital and get that patent right into surgery. The image 30 is accessible even from an handheld device 50 such as an Ipad® or Iphone®. The hospitals would also be saving on I.T. costs of managing all of this imagery in-house, which entails setup and integration to all other practices that the hospital is contracted with. This means setting up VPN's all over town and securing transmission of actually copying and moving imagery is no longer needed. Using the image management system 10 of the present invention to centralize images 30 and view them remotely in the cloud 40 changes everything. This also gives all referring doctors or PCPs the ability to see their patent's data/images in real time. They no longer need to wait for an image to be copied/compressed or printed and delivered. Being that the images are centralized and accessible from anywhere, this allows the elimination of duplicate images. Images 30 are no longer needed to be taken twice due to the fact that they can now be viewed in real time from anywhere with zero quality loss. Also consider the ease of setup and configuration. No more does an I.T. department need to set anything up to make this work.

Step by Step Process Example of RIMS embodiment:
1. A patient comes to a Radiology center 20 for a scan
   a. Patient gets on the MRI bed for an image 30 that will now be taken.
   b. Now there is an option of how and where that image 30 gets stored. Typically a radiology center 20 houses a PACS machine 22 that handles the local storage and local viewing of the image taken. A PACS system usually includes a controlling server and storage array. The PACS system that is connected to the MRI machine 24 can now to be considered as an optional piece of equipment to store and allow local viewing of the images 30. RIMS 10 has the capability to directly receive these images 30 strait from the MRI machine 24 into the RIMS cloud 40 without dumping them locally to any PACS machine 22.
   c. Radiology center 20 has to input a Port/IP address into the MRI machine 24 to then tell it to now send images 30 directly to RIMS 10. This is a onetime setup with two small numbers to input. Typically this can be done with a simple phone call to the Radiology center technician who will then add this address to the MRI machine 24 and/or the onsite PACS machine 22.
   d. RIMS 10 then receives this image 30 directly into the RIMS cloud 40 located at RIMS datacenters 12a, 12b, . . . 12n. As a patient is being scanned, the images 30 have already begun moving to the datacenters 12a, 12b, . . . 12n and will be fully transferred before the patient gets off the MRI bed. This will be the case if the Radiology center 20 chooses to use a PACS system 22 or direct MRI 24 link strait to the cloud 40.
   e. Image 30 is then Accepted and sorted by step 2
2. Imagery is now received into the data center into the RIMS system 10
   a. A TCP request is now received by Firewall Equipment at the Rims Datacenters 12a, 12b, . . . 12n.
   b. The TCP request is detected and noted by the sourcing port and IP address.
   c. The TCP traffic can then be mangled and Network Address Translated to the proper ports if necessary.
   d. The Image 30 which is transmitted through the TCP port and IP address is now passed onto the Imaging servers.
3. Image is now received into the Imaging servers (14, 16a) and processed.
   a. All image servers are running a custom created service that is listening for an inbound DICOM image.
   b. The custom created Windows Server Process is then functions to accept the inbound DICOM image and is then able to sort it properly into the RIMS image store.
   c. The service that is listening for these images as they are received is able to sort them according to Dr. for later HIPAA compliant viewing
   d. The RIMS created Service is also seamlessly reading all of the DICOM files META Data and stripping it into a MYSQL database 15. META Data is 300 lines of information that is text based and pertains to the patient and everything about them, their insurance company, the body part, the modality, etc . . . META data.
   e. At this point the imagery has been properly sorted by Dr. on RIMS imaging servers 16b, and all META Data is now assembled into patient database 15 containing all the information possible for that patient.
   f. The entire process to this point is completed before the patient leaves the MRI bed.
4. Deployment and Image access for the Providers 50.
   a. A 14 k, non executable, shortcut is now made available to any Dr, any mobile internet device, any PC or Mac, from anywhere in the world. This is a shortcut that is available by email, link, USB drive, or any other method of copying and taking this 14 k file with you.
   b. Dr goes to the link “http://networkextreme.net/imaging.rdp” and downloads the shortcut to any computer 52 anywhere in the world.
   c. Dr clicks on the shortcut and is then prompted for a username and password.
   d. Dr. types in his username and password; based on the username and password entered will dictate which viewer remotely deploys and which patients are shown within that viewing software. Example: If Radiologist (A) uses a GE viewer to view his patient images at his Radiology center, then this is the viewer that will deploy remotely to him offsite without installing the GE software on the viewing machine. If Dr (B) who prefers a different viewer or EMR application to view images, say Eclinical Works, then this is the application that will deploy for Dr (B) based on the username and password he has typed in.
   e. Once the Dr's chosen viewing application has deployed on the viewing machine 14, the Dr can then report and read and image that is NON Compressed and in RAW DICOM format.
   f. The Image and application deployed is not existing on the client PC 52 that the Dr is sitting in front of. The Image and the application exist in the RIMS cloud 40 and are deployed remotely without any files transferring. Therefore all images are instant and viewable in real time with no downloading and no delay
   g. All images are now contained in the deployment method due to the fact that the images and image viewing application are NOT running nor locally installed on the viewing station device 52 (PC/Ipad/Iphone/Mac). All processing power and storage is being handled by RIMS datacenters 12a, 12b, . . . 12n. The image is never moved nor transferred out of the RIMS datacenters 12a, 12b, . . . , 12n.
5. Insurance Carrier Interface “Claim Pro”—Catch Fraud, Duplication, unnecessary and poor quality images.
   a. As noted in section 3, as all images are received by the RIMS system 10 are now sorted and all META data is processed into a database at the RIMS datacenters 12a, 12b, . . . 12n.
   b. Insurance carriers 60 now have access to a Web Site interface called “Claim Pro” which is running on RIMS data center web servers.
   c. Claim Pro is a Web Site Interface that queries the MYSQL database 15 that RIMS has created during the process of accepting, receiving and sorting images 30 with META Data.
   d. Insurance carriers 60 can now log into Claim Pro's web site interface and immediately they receive a popup notice if there is any patient duplication or fraud in real time. Searchable by any time frame.
   e. META data is now being queried in real time as the images 30 come into the datacenters 12a, 12b, . . . 12n for certain criteria to benefit the insurance carrier 60.
   f. Claim Pro is cross referencing multiple items in the RIMS database 16b based on the META data. Such as: patient name, DOB, modality, image taken, payer ID, patient ID, Rad center, Dr name, etc . . . . If things don't match up an alert is generated in the Claim Pro web interface.
   g. For eliminating duplication, the system is able to detect if the same patient has had more than one scan for the same body part within a month's time before an additional insurance claim is paid for twice. Example: Patient gets hurt and goes to the hospital. The hospital does an MRI. Then the same patient a week later is feeling pain so he goes to see his PCP. PCP then refers the patient down the hall for another scan due to the fact that the PCP needs to figure out the problem and has no immediate access to the MRI images that the hospital has taken. This means that without Claim Pro and RIMS the insurance carrier would approve the second pre-auth for another image to be taken. Then both the patient co-pay ($475) and the insurance claim are then paid twice. Whereas with RIMS the Dr can access the hospitals MRI in real time with just a shortcut and no I.T. department setup or interaction. If the second radiologist fails to look then the insurance carrier will see an automatic alert to deny the second pre-auth that the second radiologist submits. So the second image will not be paid for by the insurance carrier and never even taken by the second radiologist.
   h. Eliminating the above means less radiation exposure for the patient as well.
   i. For eliminating fraud—when any of the patient information does not match the META data then a fraud alert is generated. Example: if a Radiology center submits a claim to a carrier for payment and the patient name doesn't match the images taken or doesn't match the patient ID given by the carrier then an alert is generated. This happens all the time.
   j. Insurance interface (Claim Pro) is able to provide the carrier with real time access to their covered patients and track there radiology history and reporting in real time. They are now also given the ability to see a patient image in real time without even contacting the Radiology center 20 to send films or disks. Typically all the insurance carrier 60 sees is the radiology report from the center with the diagnosis, and that's it. Now this newly created insurance interface has the ability to let the carrier log in and see that image in real time. As well as check it for quality and calibration.
   k. There is 40% loss monthly in radiology for an insurance carrier 60 due to things like duplication and fraud. The created insurance interface notifies the carrier in real time if a patient image has already been taken within the past 30 days. This allows the carrier to deny the second Pre-Authorization for a second radiology center to take the same body part image twice. Hence eliminating an average of 20% duplication alone in the industry.
   l. Claim Pro uses designed algorithms to dictate alerts to give the insurance carrier 60 a tool that they then can use to eliminate their waste. This system is also setup in a seamless fashion. Currently when any radiology center 20 is going to get a pre-auth before taking an image they are instructed by the carrier 60 to go to a website and fill out a pre-auth form. Then the carrier returns an auth # that allows the center to take an image . . . . With Claim Pro the radiologist instead would go to the Claim Pro interface and fill out the same type of pre-auth form. Except with Claim Pro, if the patient image is already in the system then the pre-auth is immediately denied without any carrier interaction. Claim Pro then immediately will provide a link to the image that is remotely deployable, instead of a pre-auth. So the carrier now saved that duplicate image from being taken and the Dr is now able to view that image in real time without retaking it.

An exemplary system for implementing the invention includes a computing device or a network of computing devices. In a basic configuration, computing device may include any type of stationary computing device or a mobile computing device. Computing device typically includes at least one processing unit and system memory. Depending on the exact configuration and type of computing device, system memory may be volatile (such as RAM), non-volatile (such as ROM, flash memory, and the like) or some combination of the two. System memory typically includes operating system, one or more applications, and may include program data. Computing device may also have additional features or functionality. For example, computing device may also include additional data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules or other data. System memory, removable storage and non-removable storage are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other physical medium which can be used to store the desired information and which can be accessed by computing device. Any such computer storage media may be part of device. Computing device may also have input device(s) such as a keyboard, mouse, pen, voice input device, touch input device, etc. Output device(s) such as a display, speakers, printer, etc. may also be included. Computing device also contains communication connection(s) that allow the device to communicate with other computing devices, such as over a network or a wireless network. By way of example, and not limitation, communication connection(s) may include wired media such as a wired network or direct-wired connection, and wireless media such as acoustic, RF, infrared and other wireless media.

Computer program code for carrying out operations of the invention described above may be written in a high-level programming language, such as C or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller. A code in which a program of the present invention is described can be included as a firmware in a RAM, a ROM and a flash memory. Otherwise, the code can be stored in a tangible computer-readable storage medium such as a magnetic tape, a flexible disc, a hard disc, a compact disc, a photo-magnetic disc, a digital versatile disc (DVD). The present invention can be configured for use in a computer or an information processing apparatus which includes a memory, such as a central processing unit (CPU), a RAM and a ROM as well as a storage medium such as a hard disc.

The “step-by-step process” for performing the claimed functions herein is a specific algorithm, and may be shown as a mathematical formula, in the text of the specification as prose, and/or in a flow chart. The instructions of the software program create a special purpose machine for carrying out the particular algorithm. Thus, in any means-plus-function claim herein in which the disclosed structure is a computer, or microprocessor, programmed to carry out an algorithm, the disclosed structure is not the general purpose computer, but rather the special purpose computer programmed to perform the disclosed algorithm.

A general purpose computer, or microprocessor, may be programmed to carry out the algorithm/steps of the present invention creating a new machine. The general purpose computer becomes a special purpose computer once it is programmed to perform particular functions pursuant to instructions from program software of the present invention. The instructions of the software program that carry out the algorithm/steps electrically change the general purpose computer by creating electrical paths within the device. These electrical paths create a special purpose machine for carrying out the particular algorithm/steps.

Unless specifically stated otherwise as apparent from the discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

It should be understood that the examples and embodiments described herein are for illustrative purposes only and that various modifications or changes in light thereof will be suggested to persons skilled in the art and are to be included within the spirit and purview of this application.

What is claimed is:

1. A computer-implemented method of medical image management, comprising:
storing a plurality of images comprising image data and metadata in a cloud environment, the cloud environment comprising one or more data centers associated therewith, each data center comprising a processing device and storage device, wherein metadata is separated from image data via the processing device and stored in a patient database;
providing access to the plurality of images via a remote log in upon authentication via the processor, wherein the access is limited to accessed data comprising images authorized for a user; and
enabling viewing and interfacing of the accessed data via a remote device for the user by deploying a cloud-enabled application for the cloud environment that executes viewing software in the cloud environment so that the remote device displays a current view of the image generated in the cloud environment, rather than transmitting the stored image itself to the remote device.

2. The computer-implemented method of claim 1 wherein storing the plurality of images in the cloud environment comprises:
receiving by a processing device of a first data center associated with the cloud environment one or more images from a remote imaging device in communication with the first data center;
separating metadata from image data for the one or more images and storing the metadata in a patient database;
replicating and transmitting the one or more images via the processor of the first data center to one or more further data centers associated with the cloud environment;
sorting the one or more images at each of the data centers associated with the cloud environment according to a predetermined storing arrangement;
storing the one or more medical images in a database associated with each of the data centers.

3. The computer-implemented method of claim 2 wherein the remote imaging device comprises a medical imaging device configured to capture images and associate the images with patient data as metadata.

4. The computer-implemented method of claim 3 wherein the remote imaging device communicates directly with the cloud environment or through an intermediate image processing and storage system.

5. The computer-implemented method of claim 1 wherein providing access to the images comprises:
receiving a remote log in request from the remote device in communication with a cloud server associated with the cloud environment, the remote device using the cloud-enabled application to access to the cloud environment;
authenticating a user of the remote device via the processor of the cloud server; and
providing limited access to the accessed data comprising images authorized for the user.

6. The computer-implemented method of claim 1 wherein enabling viewing and interfacing of the accessed data comprises:
deploying on a server in the cloud environment a preferred viewing software for the authenticated user to interface with and view the accessed data comprising images authorized for the user;
retrieving images by the preferred viewing software on the server in the cloud environment;
generating a current view of the image by the preferred viewing software in the cloud environment so that the remote device displays the current view of the image, rather than transmitting the stored image itself to the remote device.

7. The computer-implemented method of claim 1 further comprising: checking the patient database storing metadata separated from image data for the one or more images for duplicates and generating an alert.

8. The computer-implemented method of claim 7 further comprising:
providing remote access to the patient database having stored therein metadata separated from image data for the one or more images, wherein the remote access is configured for receiving and processing data queries regarding the metadata and sending reports and generated alerts.

9. The computer-implemented method of claim 8 further comprising:
receiving a pre-authorization request prior to taking an image of a patient;
comparing the pre-authorization request for the patient with data in the patient database; and
upon finding a match for the patient for which an image has already been taken and stored in the cloud environment, providing a link to an associated image in the cloud environment and denying the pre-authorization request.

10. A computer system that facilitates medical image management, comprising:
one or more server devices adapted to receive and centrally store a plurality of medical images in a cloud environment, the server devices comprising a processor and storage device, wherein metadata is separated from image data via the processor; the server devices further adapted to provide access to the medical images via a remote log in upon authentication via the processor, wherein the access comprises access to view data authorized for the particular user and images associated therewith; and enable viewing of accessed data via a remote viewing device for the particular user that deploys a cloud-enabled application in the cloud environment.

11. A system for managing medical images and data in a cloud environment, comprising: a network interface to a set of cloud-based networks; and a processor, communicating with the set of cloud-based networks to execute the image generation service, the processor being configured to:
store a plurality of images comprising image data and metadata in a cloud environment, the cloud environment comprising one or more data centers associated therewith, each data center comprising a processing device and storage device, wherein metadata is separated from image data via the processing device and stored in a patient database;
provide access to the plurality of images via a remote log in upon authentication via the processor, wherein the access is limited to accessed data comprising images authorized for a user; and
enable viewing and interfacing of the accessed data via a remote device for the user by deploying a cloud-enabled application for the cloud environment that executes viewing software in the cloud environment so that the remote device displays a current view of the image generated in the cloud environment, rather than transmitting the stored image itself to the remote device.

12. A non-transitory computer-readable medium encoded with programming instructions that, when executed by a processor, cause the processor to performs the following steps:
store a plurality of images comprising image data and metadata in a cloud environment, the cloud environment comprising one or more data centers associated therewith, each data center comprising a processing device and storage device, wherein metadata is separated from image data via the processing device and stored in a patient database;
provide access to the plurality of images via a remote log in upon authentication via the processor, wherein the access is limited to accessed data comprising images authorized for a user; and
enable viewing and interfacing of the accessed data via a remote device for the user by deploying a cloud-enabled application for the cloud environment that executes viewing software in the cloud environment so that the remote device displays a current view of the image generated in the cloud environment, rather than transmitting the stored image itself to the remote device.

13. The computer-readable medium of claim 12 wherein programming instructions that, when executed by a processor, store the plurality of images in the cloud environment, cause the processor to perform the following steps:
receive by a processing device of a first data center associated with the cloud environment one or more images from a remote imaging device in communication with the first data center;
separate metadata from image data for the one or more images and storing the metadata in a patient database;
replicate and transmit the one or more images via the processor of the first data center to one or more further data centers associated with the cloud environment;
sort the one or more images at each of the data centers associated with the cloud environment according to a predetermined storing arrangement;
store the one or more medical images in a database associated with each of the data centers.

14. The computer-readable medium of claim 13 wherein the remote imaging device comprises a medical imaging device configured to capture images and associate the images with patient data as metadata.

15. The computer-readable medium of claim 14 wherein the remote imaging device communicates directly with the cloud environment or through an intermediate image processing and storage system.

16. The computer-implemented method of claim 12 wherein programming instructions that, when executed by a processor, provide access to the images, cause the processor to perform the following steps:
receive a remote log in request from the remote device in communication with a cloud server associated with the cloud environment, the remote device using the cloud-enabled application to access to the cloud environment;
authenticate a user of the remote device via the processor of the cloud server; and
provide limited access to the accessed data comprising images authorized for the user.

17. The computer-readable medium of claim 12 wherein programming instructions that, when executed by a processor, enable viewing and interfacing of the accessed data, cause the processor to perform the following steps:
deploying on a server in the cloud environment a preferred viewing software for the authenticated user to interface with and view the accessed data comprising images authorized for the user;
retrieving images by the preferred viewing software on the server in the cloud environment;
generating a current view of the image by the preferred viewing software in the cloud environment so that the remote device displays the current view of the image, rather than transmitting the stored image itself to the remote device.

18. The computer-implemented method of claim 12 further comprising programming instructions that, when executed by a processor, cause the processor to check the patient database storing metadata separated from image data for the one or more images for duplicates and generate an alert.

19. The computer-readable medium of claim 18 further comprising programming instructions that, when executed by a processor, cause the processor to:
provide remote access to the patient database having stored therein metadata separated from image data for the one or more images, wherein the remote access is configured for receiving and processing data queries regarding the metadata and sending reports and generated alerts.

20. The computer-readable medium of claim 19 further comprising programming instructions that, when executed by a processor, cause the processor to:
receive a pre-authorization request prior to taking an image of a patient;
compare the pre-authorization request for the patient with data in the patient database; and
upon finding a match for the patient for which an image has already been taken and stored, provide a link to an associated image in the cloud environment and deny the pre-authorization request.
